(19) United States
(12) Patent Application Publication
(10) Pub. No.: US 2013/0185847 A1
(43) Pub. Date: Jul. 25, 2013

(54) Reflective Substrate

(71) Applicants: David Paul Steenson, Leeds (GB); Stephen John Russell, Leeds (GB)

(72) Inventors: David Paul Steenson, Leeds (GB); Stephen John Russell, Leeds (GB)

(73) Assignee: UNIVERSITY OF LEEDS, Leeds, West Yorkshire (GB)

(21) Appl. No.: 13/877,843

(22) PCT Filed: Oct. 5, 2011
(86) PCT No.: PCT/GB11/51908

§ 371 Date: Apr. 4, 2013

(30) Foreign Application Priority Data
Oct. 5, 2010 (GB) 1016748.4

(51) Int. Cl. H01Q 15/18; A41D 31/00

(52) U.S. Cl. CPC H01Q 15/18; A41D 31/00
USPC 2/243.1; 342/7

(57) ABSTRACT

The invention provides a reflective material, adapted for the efficient retro-reflection of radiation emitted by radar, the material comprising a multiplicity of reflective entities which are typically embedded in a substrate, the multiplicity of reflective entities being comprised in at least one reflective surface or electrically conducting surface, and the at least one reflective surface or electrically conducting surface comprising an electrically conductive coating, a high permittivity material, a foil, a film or a fabric formed from electrically conducting fibres or filaments. The reflective entities may comprise discrete shaped entities, most preferably di- or tri-hedral shaped entities, which are preferably embedded in a high permittivity medium. More preferably, the reflective entities are comprised in the machined surface of a reflecting substance comprising a polymeric sheet material which is machined to provide an irregular patterned surface. Most preferably, the substrate comprises a textile material in the form of a garment. Reflective material and textile garments according to the invention provide a highly efficient means for the reflection of incident radar radiation and offer significant benefits in terms of the visibility of wearers to drivers of oncoming vehicles in poor and dark light conditions, thereby facilitating a marked improvement in road safety statistics and enhancing search and rescue detection and success rates, especially in severe and inclement weather conditions.

### FIELD OF THE INVENTION

The invention relates to a means for facilitating the efficient reflection of radiation by a substrate. More specifically, it is concerned with the provision of a substrate material which reflects radar radiation with a high degree of efficiency and finds potential application in high-visibility to radar safety clothing, as well as related protective and outdoor pursuits equipment.

### BACKGROUND TO THE INVENTION

The numbers of people killed or injured in Great Britain as a consequence of road traffic accidents continues to be a source of grave concern. Thus, for instance, the total number of people killed or seriously injured in Great Britain each year during the last decade has been around 27,000, which is equivalent to an average of 74 people each day, or roughly 0.04-0.05% of the population annually and, although these figures have been dropping throughout the last decade, they are still at a very serious level which needs to be reduced by any means possible. Of this number, approximately 6,000 were pedestrians, of which 500 died and, of the 6,000 pedestrians seriously injured, 1,660 were children, of whom 81 died. In addition to this number another 5,800 motorcyclists and 2,700 cyclists were killed or seriously injured, bringing the total number of vulnerable road users killed or seriously injured annually in Great Britain to somewhere in the region of 14,500.

The number of fatalities was seen to fall from 3,221 in 2004 to 3,201 in 2005, but this represents a reduction of only around 1 per cent, and it is notable that this number has remained fairly constant over the period of the last 10 years. Of the total of 3,201 in 2005, 671 were pedestrians and whilst, at 21% of the total road deaths, this represents the lowest total for over 40 years, there is still clearly scope for significant improvement in these figures.

It has been established that vehicle speed is a critical factor in determining the severity of an accident and, most specifically, is crucial in relation to accidents involving pedestrians. Thus, whilst collisions involving pedestrians which occur at speeds in excess of 40 mph generally result in death or serious injury, most pedestrians survive collisions which occur at speeds below 30 m.p.h., and are less severely injured. Most notably at 23 mph a pedestrian involved in a collision with a car has an 87% chance of survival, whilst at 30 mph this drops to 27%, and at 38 mph it falls to 1%, thereby highlighting the fact that the impact energy rises with the square of the speed.

The number of cyclists killed or seriously injured is roughly one half to one third of the number for pedestrians but with increasing numbers of cyclists taking to the roads then this figure may increase over the coming years rather than decrease, so it is required to find a technology which would potentially have a wide application in this area.

The challenge, therefore, is to find means by which these disturbing statistics may be significantly improved and, clearly, there is an urgent need to provide an engineering solution to the problem which increases the ability to detect a pending collision earlier, has the potential to more rapidly reduce the vehicle's speed, and thereby minimises the consequences of a subsequent collision between a motor vehicle and a vulnerable road user. It is also desirable that the technology should also work together with any existing or developing visually based warning systems and should complement such approaches to increase the confidence in any pedestrian identification decisions or tracking problems.

Apart from the obvious expedient of ensuring greater care and lower speeds on the part of drivers, various approaches are possible. Thus, for example, some motor manufacturers have already developed emergency brake assist (EBA) systems which are designed to work in co-operation with anti-lock braking systems (ABS) in order to reduce braking distance by ensuring optimum emergency braking performance.

An alternative, or complementary, approach by the motor manufacturers has been the installation of radar-based detection systems, which are able to provide advanced warning of potential collision hazards, particularly those ahead of the vehicle. Such systems may serve to provide a visible or audible warning to the drive of a potential collision hazard or, additionally, may co-operate with an EBA system so as to effect emergency braking. Volvo, in particular, has promoted this approach and has already fitted the capability of automated emergency breaking to its XC60 range of cars. However, the efficiency of these detection systems is obviously highly dependent on their ability to detect or “see” potential hazards as determined by the radar return or visibility of the potential hazard. Hence, in the case of a pedestrian, the efficiency of detection is closely related to the visibility of the pedestrian in terms of the incident radiation, and the extent to which radiation is successfully reflected back to, and detected by, the detection system on the vehicle.

It is obviously important that pedestrians should ensure maximum visibility for vehicle drivers, and they have long been advised to wear light, and preferably reflective, clothing, especially during the hours of darkness. However, such clothing is essentially designed to be efficient in terms of the reflection of visible light, thereby increasing visibility to the naked eye and visually based systems only. Furthermore, the vehicle driver has to react to any impending collision and it is well known that the reaction time alone to a potential hazard is equivalent to approximately 1-2 seconds prior to the point at which breaking even commences (or: 5-15 m at 20 mph; 10-20 m at 30 mph, and 15-30 m at 40 mph) and the stopping distance is then roughly double that. In other words, at 30 mph the vehicle is likely to have travelled 20-30 m before stopping and at 40 mph this would be nearer 50 m. The consequence, then, is that in the urban environment there is little time for the driver of the vehicle to react to avoid such collisions and this is where an automated response by the vehicle would offer the most potential to minimise the frequency and severity of severe accidents. The present inventors, therefore, have addressed the problem of increased visibility of vulnerable road users to the radars and detection systems employed in many motor vehicles, which typically rely on the detection of reflected radiation emitted by the radar systems, which generally operate at millimetre wavelength frequencies.

This advanced warning of a pending collision could provide both an early audible warning to the driver to take emergency action, and could prime, or even take partial control of, the vehicle's braking system in anticipation of the driver's braking action and an impending collision. However, and much more significantly, since the reaction time equates to about 2 seconds for the driver and less than a few milliseconds for the automated system, this implies that the collision speeds for the majority of cases could be reduced to below that which would cause serious harm for the majority of common urban speeds, i.e. less than 30 mph. Additional applications of such new radar reflective materials could be in land and sea search and rescue to enable location-detection. It would be intended that such a reflective material should be wearable, forming part of a jacket or clothing accessory, but may also be integrated within a garment or object, for example: flotation devices; water-borne craft; sports equipment; rucksacks; and other protective equipment and the like.

Well-established systems are available for enhancing the visibility of clothing under incident illumination, the most familiar being the material trade-named Scotchlite™ Reflective Material produced by 3M™, which relies on the use of multiple microscopic glass beads in the manufacture of reflective tape which is applied to the outside surface of clothing in order to improve visibility. However, this system is only effective in the context of visible light and the present inventors have, therefore, investigated alternative approaches which can achieve similar effects in terms of incident microwave or millimetre wavelength radiation, and thereby improve visibility in terms of these radar-based detection systems which, notably, are able to function equally effectively under all visible light conditions and even in fog, mist and heavy rain and spray. The proposed radar reflective materials complement rather than detract from the functionality of the Scotchlite™ coating. Additionally, the new radar reflective material does not need to be installed at the surface of the product and can be placed within the product and between layers of other materials.

It should be noted that the present inventors believe that the methodology used to achieve the retro reflective nature of the Scotchlite™ materials to incident visible light, is not directly applicable to the millimetre and microwave range of the electromagnetic spectrum since, at these frequencies, the wavelength is some 5,000 or more times longer than that of visible light, thereby implying that, in order to achieve the same effect, the Scotchlite™ material would need to be reengineered and more than 500 mm thick.

The present invention seeks to maximise the per unit area retro-reflectivity to a range of wavelengths and also seeks to engineer the maximum performance at the specific frequencies of both short and long range vehicle radars (i.e. 24 and 78 GHz). The engineered radar reflective material will therefore employ a matrix and/or patchwork of tri- and di-hedral shapes to give a strong retroreflective response to the radars employed for the specific applications. A further concern of the inventors was to develop a reflective material which could be worn unobtrusively by a user and which could, therefore, be readily incorporated within a garment to be worn by a user without compromising its appearance or more general function.

It is seen that further modifications to the basic retro-reflective material will permit the technology to find applications in long range search and rescue situations. Where the radars and discrimination issues are different, modifications to the size, shape and distribution of the arrayed shapes will be required in order to maximise the response from these radar systems. In short, each radar application would benefit from modifications to the basic principle of operation in order to give the engineered material an optimised retro-reflected response; for example the returned phase, amplitude, frequency or polarisation may be modified or modulated to favour increased discrimination and the generally passive nature of the invention may be complemented by an active aspect or component which amplifies or modulates the returned signal.

### SUMMARY OF THE INVENTION

As has been discussed, the anticipated applications for the present invention are in clothing and equipment for pedestrians and other vulnerable road users, and in outdoor search and rescue clothing and equipment. The general principle to which the inventors have directed their attention is to increase the reflected radar return of an “engineered” material by factors of between 100 and 100,000 (depending on the radar types, frequencies, ranges and conditions) compared with the background area. By harnessing the characteristic and high reflection from the engineered material, together with the increasingly automated vehicle systems which control velocity and breaking, it is proposed that the widespread adoption of the technology will lead to significant reductions in the numbers and severity of road traffic accidents involving vehicles and vulnerable road users. Furthermore, modified versions of the engineered material could also be used to significantly increase the visibility to radars, as used in many search and rescue vehicles, of wearers of such engineered materials such as when lost at sea and/or in outdoor situations, where the weather conditions, large search area or terrain make search and rescue by foot impossible.

Thus, according to a first aspect of the present invention, there is provided a reflective material, adapted for the efficient retro-reflection of radiation emitted by radars, wherein said material comprises a multiplicity of reflective entities, wherein said multiplicity of reflective entities are comprised in at least one reflective surface or electrically conducting surface, and wherein said at least one reflective surface or electrically conducting surface comprises an electrically conductive coating, a high permittivity material, a foil, a film or a fabric formed from electrically conducting fibres or filaments.

In preferred embodiments of the invention, said reflective entities are embedded in a substrate, preferably a flexible substrate, typical examples of which include textile, non-woven or film substrates, or substrates comprising a conformable or shaped material. Most preferably, said substrate comprises a textile or non-woven substrate which is suitable for integration within a garment construction.

Typically, said radiation emitted by the said radars has a wavelength in the long wavelength microwave millimetre wave or sub-millimetre wave region. Exemplary values are, for example: between 60 and 80 GHz for automated cruise control and collision avoidance (as already standardized in Japan and Europe); 24 GHz may be used for collision priming and warning; 9-10 GHz is suitable for search and rescue (S&R). These values equate to free pace wavelengths of 5 mm, 3.9 mm, 12.5 mm and 33-30 mm, respectively. Furthermore, the technology of both the radars and the engineered fabric can be extended to general work-wear and working situations such as vehicle loading yards, construction sites, railway maintenance facilities, etc., where moving machinery and vehicles may pose a hazard to workers in busy and cluttered environments. The retro-reflected characteristic as proposed is tailored to the radar and application (as is the modulation method and characteristic), as necessary.

In terms of achieving efficient reflection of said radiation, the material of the present invention has been demonstrated to retro-reflect a large proportion of incident radiation, generally in the region of >50% to 90%, as compared to measured figures of much less than 1% signal return for uncoated adults, even at close ranges (<30 m).

Optionally, said reflective entities may comprise discrete shaped entities which may, for example, comprise trihedral and dihedral shapes. The exact size and arrangement of these shapes depends on the position and orientation of the product within which they are installed, so as to obtain maximum retroreflective return in combination with the characteristics of the illuminating radar. Furthermore, the composition and structure of the reflective material may be modified to provide a characteristic “signature” or modulation to further enhance the detection of the engineered material.

The optimum dimensions and orientation of said shaped entities are generally in the range of 2-5 mm (vertical height), depending on the radar in question. The move to increased radar frequencies of around 140 GHz has been considered, but has not yet been pursued due to the fact that there is insufficient motivation to develop the technology. In the case of search and rescue systems, the sizes of the entities could be as large as 80 mm, but this will be readily accommodated within present designs of buoyancy aids and other specialist clothing and emergency devices. However, the optimum shape and size of said reflective entities is dependent on the wavelength and characteristics of the incident radiation. In the context of European vehicle radars, the constituent shapes will be engineered to give an optimised response at 78 GHz and 24 GHz, as necessary.

Said discrete shapes are preferably air-filled dihedral and trihedral three-dimensional shapes with one side metallised; alternatively, such shapes are embedded in a high permittivity (εᵣ>8) medium, such as a high dielectric loaded polymer. In one embodiment, this can be 40-60% w/w TiO₂ in polyethylene. The selection of polymer also depends on the performance requirements of the product in which the substrate is to be integrated in respect of parameters such as moisture vapour transmission, air permeability, mechanical properties and long term durability subject to wear and repeated washing.

In certain embodiments of the invention, said discrete shapes are comprised of a high permittivity medium within said substrate, ideally with a permittivity in the range of 10-100. Typically, said high permittivity medium comprises a ceramic material such as TiO₂ (εᵣ>80) powder dispersed in polyethylene. Again, the selection of the optimum high permittivity material for a given embodiment of the invention is dependent on the wavelength of the incident radiation, as well as cost constraints. The use and position of the resultant shapes will be optimised such that they do not compromise the style, shape or feel, or the breathability, of the host fabric. The polymer component may be selected from polymers including, but not limited to, polyolefins, polyamides, polyesters, polystyrenes, polyacrylonitriles and polyvinylchlorides.

More preferably, however, said reflective entities are comprised in the machined surface of a reflecting substance which comprises arrays of shaped entities. Typically, said reflecting substance may comprise a suitable polymeric plastic material such as, for example, polyethylene, polypropylene or polytetrafluoroethylene (PTFE). Generally, said reflecting substance is provided as a sheet or powder material which may be machined, extruded, thermally embossed, thermo-formed or moulded to provide an appropriately patterned surface. Typically, said pattern may be in the form of a hemisphere reflecting surface, retro reflector di- or tri-corner, and possibly quad-corner, reflecting surface, dihedral striped reflecting surface, or a combination of these forms, depending on the proposed application.

As previously stated, said multiplicity of reflective entities are comprised in at least one reflective or electrically conducting surface. The reflective or electrically conducting surface comprises a reflective layer comprising an electrically conductive coating or high permittivity material, preferably in the form of a sprayed or vapour-deposited film, but may also consist of a foil, a film, or a fabric formed from electrically conducting fibres or filaments. In the case of the latter, the fibres or filaments may be of homogeneous composition or may be coated with electrically conducting particles. Most preferably, said reflective layer comprises an electrically conductive metal layer or a dielectric mirror. Preferred metals in this context are gold, silver or nickel.

Most preferably, said reflective material is embedded in a host textile material, especially preferably in the form of a garment. The use and position of the said shaped entities is optimised within said garments such that they do not compromise the style, shape, feel or breathability of the host fabric. In typical embodiments of the invention, said reflective material is embedded in said host material so as to provide alternate raised and sunken regions in the fabric.

In particularly preferred embodiments, said reflective material comprises a light (typically 5-250 g/m²) and flexible, but specifically sculptured sheet and/or panels embedded within the lining of outdoor clothing or equipment. This sheet may or may not be composed of a dielectric loaded polymer and is part metallised, depending upon the final application or target frequency. The sheet is a porous, predominantly metallic, film or foil formed as a laminate between two thin plastic films, for mechanical and environmental protection. Alternatively, a woven fabric comprised of metallic wire filaments formed into the necessary shapes, and with or without a protective over-layer, may be used. The shaped foil or woven surface is employed either in its raw form or as the backing material to a thicker dielectric surface layer, depending on the application and the available reflector area. The resultant material is used either as a continuous lining or as panels, depending on the application and nature of the final composite reflective material.

The reflective material may optionally be constructed from film, laminate, coated substrates, textiles or nonwoven materials that are formed into a three-dimensional surface by such methods as moulding, pressing, embossing, thermo-forming, vacuum forming or any other technique will known to those skilled in the art.

In certain embodiments of the invention, the reflective material may be produced by utilising a thermoplastic or thermoset elastomer, wherein an elastomeric polymer film supports a metallised or reflective surface. Thus, the elastomer may be thermo-formed to provide the required three-dimensional form, whereupon the metal component is added to the elastomeric film by means of coating, impregnation, printing or vapour deposition, or other deposition or coating method well known to those skilled in the art.

Depending on the application and nature of the discrimination problem resulting from background clutter it may be necessary, taking into account the radar characteristics and signal processing modalities, to enable the reflective material with a passive modulation characteristic through control of one or more of the phase, polarisation, amplitude, or frequency of the reflected signal, as appropriate. Each modulation approach is dependent on the detection capabilities of the interrogating radar and may require a different methodology to the modification of the static or dynamic electrical properties of the composite film. Combinations of modulation approaches may also be considered for maximum generality and effect.

Furthermore, under certain circumstances and applications, primarily a long range search and rescue application but not exclusively so, an active modulation and/or amplification approach may also be incorporated as a complement to the passive characteristics of the material. Said active approach may be one of simple dynamic modulation of the reflective properties of the material through modification of the electro-optical or acouso optical material properties.

A further modification to the underlying passive retro-reflective characteristics may be the incorporation of a retroreflective amplifier or array thereof, which would have the added benefit of being able to return an amplified retro-reflection, and integrated antenna with or without further electronic modulation of the returned response.

One possible form of the “active” modulation approach previously discussed is the provision of a further embedded modulation code, such as a Morse code series of letters, e.g. SOS, in the form of a periodic reflected response, or as a separate radio transmission, as has been employed in RACONs or radio buoys. Said radio-transmitter or active retro-reflection and amplification approaches could be used as stand-alone methodologies but would be preferred as an extension or compliment to the passive properties of the composite material hereinbefore disclosed.

The exact form of composite material and electronic or electromagnetic properties depends on the application in question, i.e. search and rescue on land or sea, or protection of vulnerable road users, or protective work-wear in hostile environments involving moving vehicles or machinery, or where there are conditions of poor visibility, such as in rescue situations involving, for example, smoke or dust filled buildings, since each of these may involve modifications of the basic radar modalities and frequencies.

In the application of search and rescue the proposed technology can be further complemented by the addition and development of a remotely operated drone aircraft fitted with appropriate radar technology, such that remote airborne searching could be envisaged. Again the exact material characteristics would be optimised to result in a maximum retro-reflective response to these specific, and perhaps bespoke, radars.

Another application of the proposed technology, could be in urban, close-quarter (and often poor visibility) anti-terrorism applications, via the use of the uniquely modulated retro-reflective properties of the proposed material where, in association with fire arms manufacturers, the unique retro-reflective “signature” of the material could be used in order to reduce the possibility of “friendly fire” incidents.

Typically, the material according to the invention provides a lightweight and compact material adapted for the efficient retro-reflection of radiation which is ideally suited to incorporation in textiles and coverings. The material is especially suited to the retro-reflection of radiation in the mm to cm wavelength range. The material typically comprises a shaped surface, multiplicity of reflective entities or arrangement of conductors which act to produce a strong, detectable returned signal. Optionally, the returned signal may also feature additional information facilitating improved identification or improved signal to noise ratio, or other variation thereof.

According to a second aspect of the present invention, there is provided a wearable textile garment comprising a reflective material according to the first aspect of the invention.

Most preferably, said textile garment comprises an outer layer and one or more inner layers. The outer and inner layers may be selected from woven, knitted, non-woven, pressed felt, polymer film, leather (virgin and reconstituted) or coated substrate materials, and combinations thereof, as well as composite materials such as that comprised of a fabric laminated to one or more polymeric films.

Preferably, the reflective material is placed within the garment, or embedded within or behind other fabrics or films such that it is not visible in a closed garment or accessory when in use, or does not affect the visual appearance of the outer or inner layers. It may be installed either in discrete panels (e.g. patches) within the garment or installed in substantially continuous form. Patches may be installed at substantially different planar orientations relative to each other to maximise radar detection at different incident angles. The variation in orientation may be arranged in a periodic, quasi-periodic or randomly repeating format.

The reflective material may optionally be installed as a drop liner between the outer layer and one or more inner layers. Alternatively, the reflective material may be installed as part of a fully integrated composite, such as is formed by laminating, fusing, stitching or otherwise fixing the reflective material between the outer layer and at least one inner layer.

The reflective material may be connected to the outer layer and at least one inner layer over its entire surface area or in specific regional locations, including at its extremities, such that shear deformation and relative displacement of layers is facilitated.

In an alternative embodiment, the garment consists of an outer layer and detachable inner layers such that the outer, inner and reflective material layers can be separated or individually replaced/renewed.

A third aspect of the invention provides a method for the detection of an object body, said method comprising providing the object body with a material according to the first aspect of the invention or a garment according to the second aspect of the invention, illuminating said object body with radar radiation and detecting retro-reflected radar radiation emitted from said object body. In preferred embodiments of the invention, said object body comprises a human being.

### BRIEF DESCRIPTION OF THE DRAWINGS

Embodiments of the invention are further illustrated hereinafter with reference to the accompanying drawings, in which:

FIG. 1 is a representation of the principle and general form for retro-reflective material where a cut-through of a simple dihedral shaped surface shows the principle of operation and includes the use of a highly reflective backing on a high permittivity substrate material and an anti reflection coating.

FIG. 2 is a graphical representation of the different responses of flat and shaped surfaces to incident radiation and shows how the specific shapes maintain a strong average retroreflected response.

FIG. 3 shows a comparison of reflectivity of radiation which is incident at different angles on a flat metal plate and illustrates the experimental set-up used to generate the data in FIG. 2.

FIG. 4 illustrates the comparative drop in reflectivity of the human body compared to an ideal reflector, and shows that reflection from the human body is <0.5% (i.e. 23 dB) lower than that of an “ideal” reflector (such as the flat and perpendicular metal plate).

FIG. 5 shows how a simple shaped dihedral foil improves the angle dependent reflectivity values which are observed when radiation is incident on shaped foil at a variety of different angles of incidence.

FIG. 6 shows examples of various simple materials and surface finishes according to the invention having differently shaped reflective surfaces wherein, on testing, each had strengths and weaknesses but, in general, the di- and tri-hedral shapes gave the strongest return.

FIG. 7 provides a close-up illustration of a hemisphere array reflecting surface embedded in PTFE according to the invention.

FIG. 8 provides a close-up illustration of a trihedral retro reflector array reflecting surface embedded in PTFE according to the invention.

FIG. 9 provides a close-up illustration of a tetrahedral array reflecting surface according to the invention.

FIG. 10 provides an illustration of a large metal retro reflector according to the invention, which is used to investigate the preservation of polarisation upon reflection from an ideal trihedral feature.

FIG. 11 is a graphical representation of the angle dependent reflection from the large metal retro reflector according to the invention which is illustrated in FIG. 10.

FIG. 12 is a graphical representation of the reflectivity of various reflector shapes according to the invention embedded in PTFE and without the use of an anti-reflection coating, wherein the radiation is incident on the PTFE surface.

FIGS. 13, 15 and 16 show renditions of dihedral panels and patchworks, as well as a trihedral surface seen from the radiation incident side.

FIG. 14 is a graphical representation of the reflectivity of various high permittivity dielectric reflector shapes according to the invention.

FIG. 17 is a graphical representation of the reflectivity of a flat thin dielectric sheet according to the invention.

### DETAILED DESCRIPTION OF THE INVENTION

The present invention is established on the premise that, by using a specially sculptured surface, a very large proportion of any microwave or millimetre wave radar generated radiation signal which illuminates an object, or is incident on an object, comprising the reflective material according to the invention will be returned by retro-reflection to the illuminating radar. The invention also requires that such a material should give a strong retro-reflection response to these millimetre wave and microwave radars, whilst not compromising the appearance or function of substrates, specifically textile garments, with which it is associated. Specifically, it is intended that the material according to the invention should be incorporated unobtrusively within the lining of the garment.

The basic principle of operation, in particular the discrimination between the engineered reflector and the reflection from the surroundings, can be further improved for specific applications by physically, acoustically and/or electrically modulating the reflectivity to give a unique and characteristic signature to the retro-reflected return. This would be in the form of a modification to the basic implementation in order to include additional control or modulation of the polarisation, phase or frequency of the reflected signal, thereby providing the opportunity for significantly improved discrimination of the desired radar return from multiple background scatterers. This is especially important in the context of long range/large sweep area search and rescue applications, wherein extreme sensitivity will be required.

In certain embodiments of the invention, the reflective material may be formed, without the need for moulding or otherwise re-shaping of a pre-formed flat fabric or film, by the weaving of continuous metallic filaments, or metallic coated or plated filaments, to produce a woven fabric wherein there are alternate raised and sunken regions in the fabric. One particularly efficacious example comprises alternate raised and sunken diamond shaped areas which produce the effect of a honeycomb. The number of honeycomb cells, their height and repeat pattern can be altered by varying factors such as the number of raised ends and picks, repeat size and filament dimensions. Suitable honeycomb weave constructions include the Brighton Honeycomb, wherein the number of honeycomb cells can be increased. Other weave constructions that enable raised and sunken regions in the fabric are Bedford cords and plain pique. It will be understood that flat woven and warp knitted fabrics produced from continuous metallic filaments, metallic coated or plated filaments can also be formed to produce raised and sunken (recessed) surfaces by means such as embossing, moulding and similar methods.

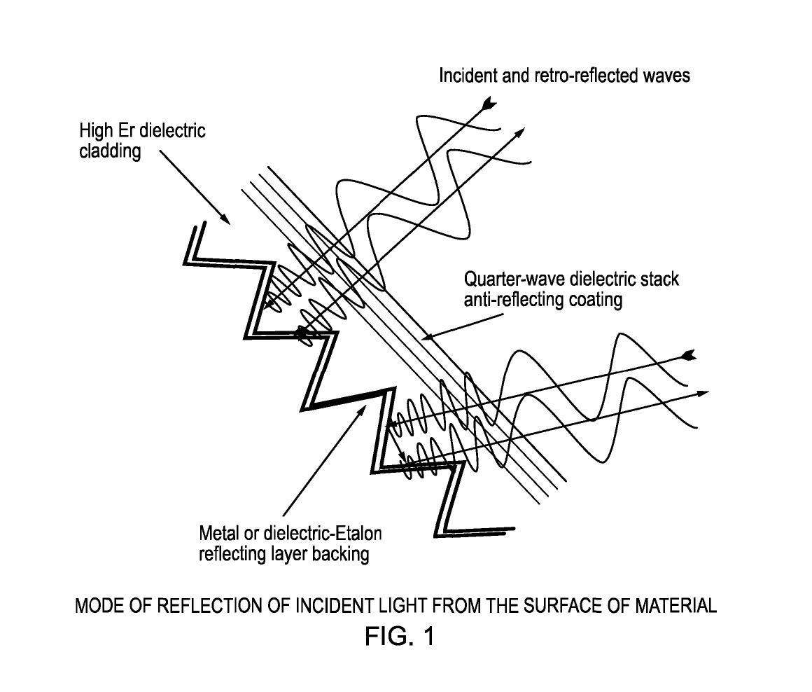

Considering in more detail the accompanying Figures, it is seen that FIG. 1 shows the basic principle of having metal or dielectric mirror backed arrays of di- and or tri-hedral shapes (for simplicity, in the 2-d plane of the page, only the dihedral surface is shown) embedded in fabric with or without the use of a dielectric in-fill and with or without an anti-reflective surface (both of which are shown in the diagram). The purpose of including a dielectric in-fill and/or an anti-reflective surface is to modify the electromagnetic properties of the incident signal in terms of frequency response, phase, polarisation or amplitude, or whichever is most appropriate for the illuminating radar system to “see” the material and for maximum visibility and discrimination.

The reflective surface shown in FIG. 1 may be a metallic weave or film, patterned or unpatterned, or formed from a combination of dielectric and partially reflective layers forming a Fabry-Periot Etalon. Such approaches would again lend the retro-reflection properties of the material a strong frequency, phase or polarisation dependent characteristic which, under some circumstances, could enhance the discrimination—and, therefore, visibility—of the material to certain radar systems. Furthermore, with the use of periodic electrical or acoustic modulation of these dielectric or metallic films, it would be possible to modulate the radar return and further improve the discrimination but, again, this exact modulation approach would need to be tailored to the radar in question.

Furthermore, by embedding an array of antennas within, or in addition to, these shapes, together with amplifying devices, it would prove possible to return a much stronger retro-reflected signal by amplifying and re-transmitting the incident signal, with or without further modulation. Such partial amplification, or active retro-reflection, would have the effect of increasing the apparent retro-reflective area, which could be significant for very long range situations, such as in search and rescue, and where observation conditions are otherwise poor due to factors including extreme distance, snow, heavy rain or high winds (and, therefore, waves at sea). Such a powered or “active” approach would be primarily used to complement and enhance the basic retro-reflective properties of the material.

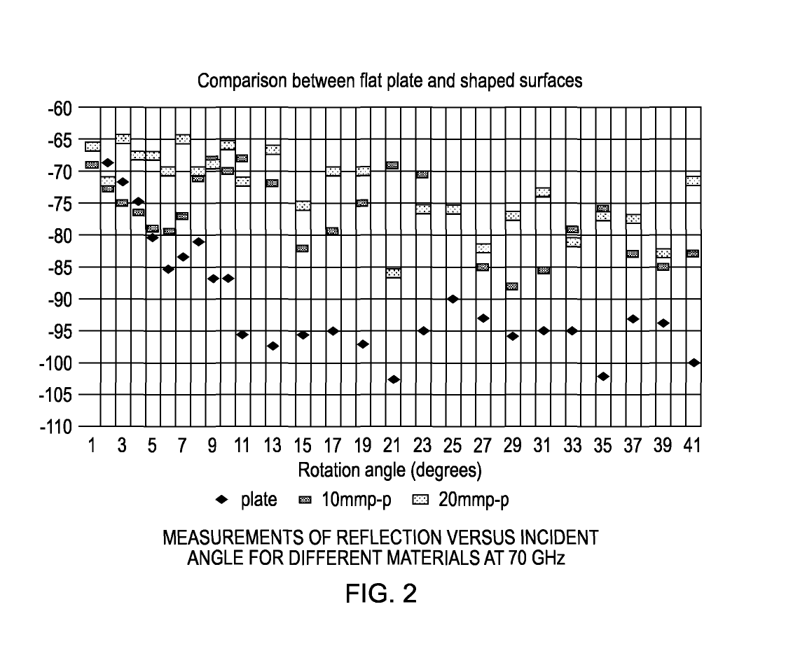

FIG. 2 shows the different responses of flat and shaped surfaces to incident radiation, and illustrates how these shapes maintain a strong average retroreflected response. For the flat plate and for off-axis angles of more than around 2-3 degrees, the retro-reflected power has dropped to 10% (from a −65 dBm return to −75 dBm) of the ideal value, and by about 8 degrees the retro-reflected power has dropped to less than 1% (i.e. −85 dBm returned power) of the ideal response. The diamond symbols denote flat plate, which gives a strong on-axis signal, but the reflected signal drops by 20 dB at 5-6 degrees off-axis and by 30 dB at 10 degrees and beyond. The larger dihedral shapes maintain a strong retro-reflected signal up to 15 degrees off axis with only a 15 dB drop on average, up to 40 degrees off axis. The drop-off in retro-reflected power with angle would be even more significant at longer distances as the results reported in FIG. 2 were for a relatively short test range.

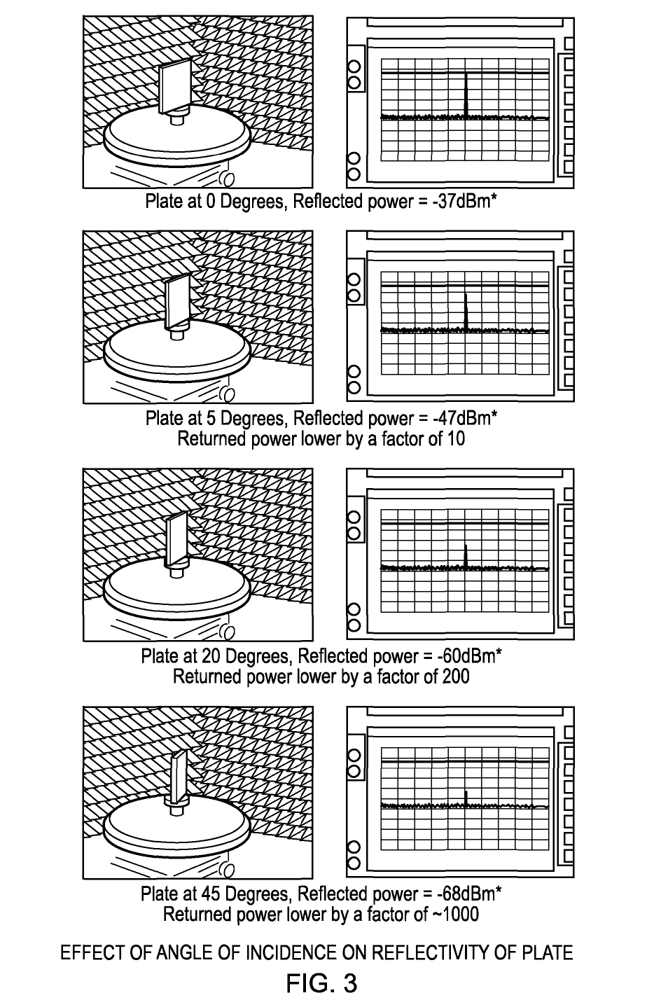

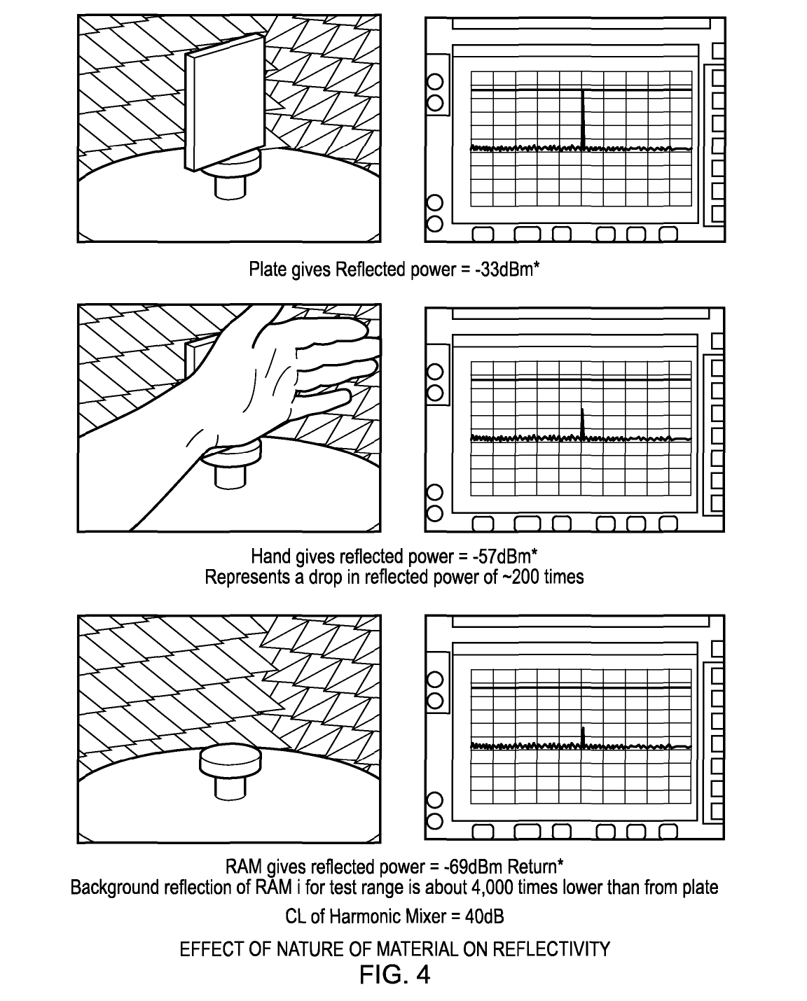

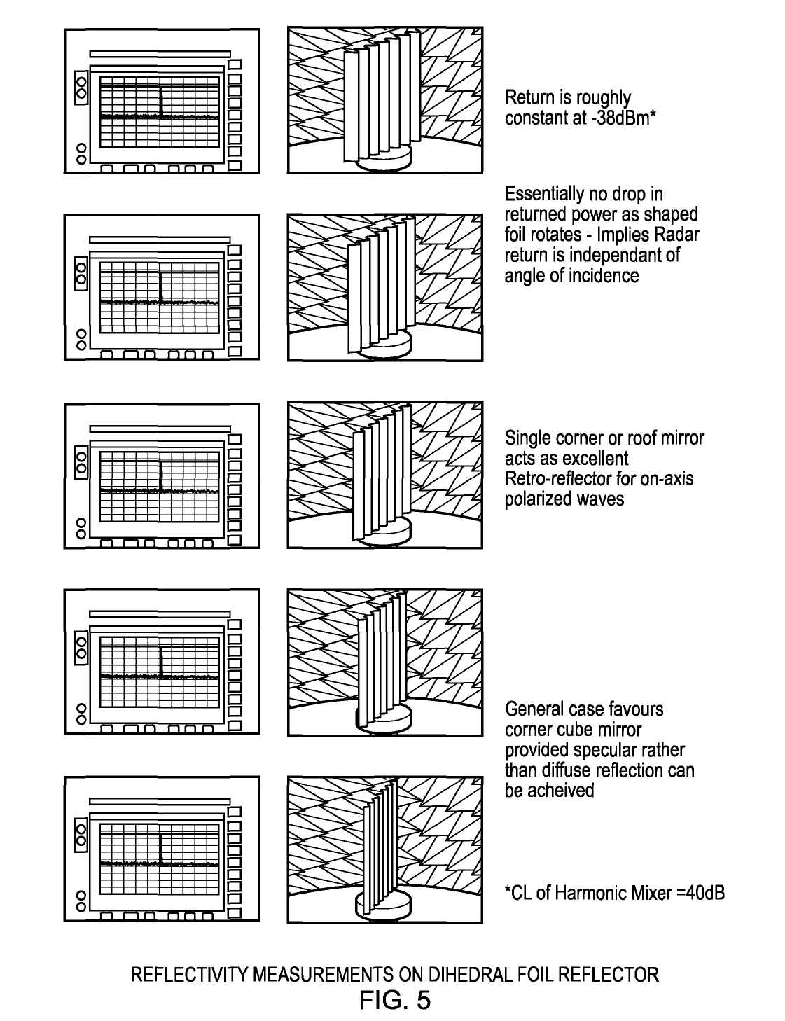

As noted above, FIG. 3 shows a comparison of reflectivity of radiation which is incident at different angles on a flat metal plate, whilst FIG. 4 illustrates the comparative drop in reflectivity of the human body compared to an ideal reflector, and shows that reflection from the human body is lower than that of an “ideal” reflector, such as the flat and perpendicular metal plates, and FIG. 5 shows how a simple shaped dihedral foil improves the angle dependent reflectivity values which are observed when radiation is incident on shaped foil at a variety of different angles of incidence.

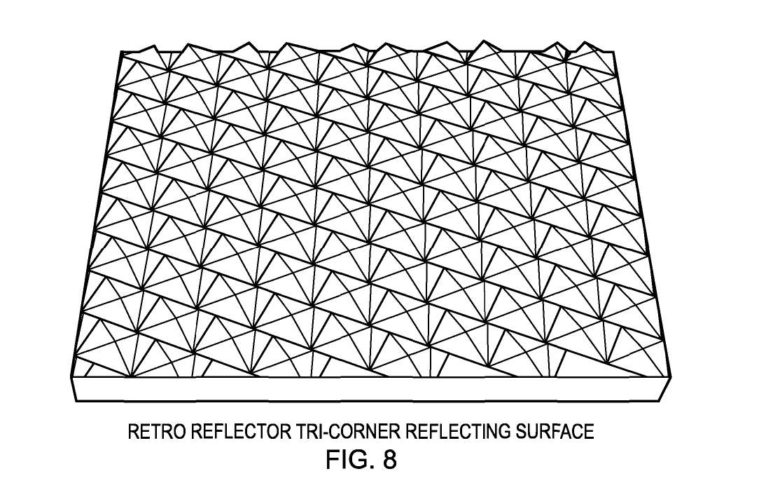

It is evident from results shown in FIGS. 2 to 5 that an appropriately engineered surface, such as those illustrated in FIGS. 5, 6, 7 and 8, can reflect between 50% and 90% of the incident radiation for a wide range of incident angles, whereas for an ideal reflector (i.e. a flat plate) rotated by even small angles off perpendicular (˜5 degrees), less than 1% (−20 dB) of the incident power is reflected (FIG. 2). Furthermore, FIG. 4 shows that simply placing a hand in front of an ideal reflector results in the reflected power dropping by over 99% (−23 dB), compared to an otherwise ideal value. However, by covering a significant area of the human body in an appropriately engineered material, such as the reflective material of the invention, the reflectivity can be clearly increased from some fractions of a percent to 90% or more, with the effect that an illuminating radar would receive a significantly greater radar return than would otherwise be the case and, therefore, the wearer would be visible at longer ranges prior to an imminent collision, giving the vehicle and driver more time to react.

FIG. 5 shows the improvement in performance (of approximately 100 times, i.e. 20 dB) over a range of angles by a suitably shaped surface when compared to a flat metal surface, as evidenced in FIG. 2 for angles between 5 and 40 degrees. This supports the argument that the material according to the invention, when incorporated in clothing, will present an almost ideal retro-reflecting surface to the illuminating radar at any of a wide range of angles. This is a feature that even a flat or conformed (to a body) metallised surface cannot satisfy since, for the majority of random incident angles, a flat surface would not be presented at the ideal angle (perpendicular to the illuminating source) and would subsequently return very little of the incident power.

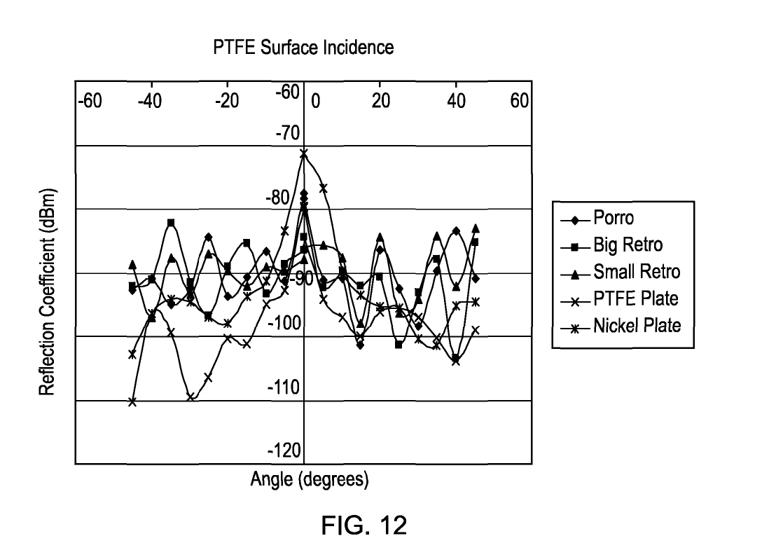

The present inventors initially investigated the use of arrays of di-, tri- and quad-reflectors embedded within a dielectric medium. The results have shown that non unidirectional response was measured, as shown in the “Big Retro” and “Small Retro” plots of FIG. 12. However, this response, although largely insensitive to incident angle, was a factor of 10-100 lower than expected, and this is thought to be due to standing wave interference within the dielectric material, which arises mainly from the lack of an effective reflection coating on the dielectric material. Confirmation of this view was provided when a response which was improved significantly resulted from carrying out reflectivity measurements on the metallised side of a similar material, as illustrated in FIG. 5.

Thus, from FIG. 2, it is possible to see a clear improvement, for angles beyond about 5 degrees off normal (perpendicular), by an average factor of 100 (or 20 dB) for both of the materials according to the invention (10 mm p-p and 20 mm p-p) when compared with the flat plate. Once the standing wave artefacts, which are thought to lead to the “oscillations” beyond angles of 10 degrees, can be improved then the improvement in returned power is expected to rise to an average value of 500-1000 times better (30 to 27 dB improvement) than that for a perfect reflector at an angle of 10 degrees or more.

The optimum size and shape of the reflecting elements, together with the optimum characteristics of the dielectric material and the anti-reflection layer, are seen to be heavily dependent on the illuminating signal wavelength, the control and manipulation of which is an important aspect in system design optimisation.

The reflectivity response of various materials is illustrated particularly in FIGS. 3-5. Thus, from FIG. 3 it is evident that the best possible return (from a flat plate mirror) is observed only when the plate is perpendicular to the incident radiation, whilst reflected power drops dramatically for a rotation angle of as little as 5 degrees. FIG. 4 highlights the poor reflective nature of human tissue, which is primarily why a retro-reflective coating is desirable. Thus, the measured reflection from a body part, compared to each of the “gold standard” optimum of an on-axis metal plate and the background signal from radar absorbent material, shows that the body is 200 times less reflective than the optimum “perfect” reflector. FIG. 5 particularly illustrates the improved performance of an appropriately treated surface, indicating that almost 100% of the incident power is returned, independent of illuminating angle and, in addition to revealing no significant drop in reflected power, the Figure shows a returned signal which is a factor of 100 above that of an equivalent area of human tissue (FIG. 4); at longer ranges, it is expected that this difference would increase by a further factor of 10 to 1000.

It should be noted that FIG. 5, which illustrates reflectivity measurements on a dihedral foil reflector showing excellent reflected signal return over many angles of incidence at 70 GHz, clearly shows the effectiveness of the present invention for a simple prototype structure, and further optimisation of the approach—by, for example, embedding a similar surface in a dielectric layer (to increase the equivalent electrical size of the shaped surface)—would be expected to enable the thickness of the structure shown in FIG. 5 to be reduced, whilst still preserving the overall response. Nevertheless, even in the absence of such optimised structures, it is clear from the available results that between 100 and 1000 times more power is reflected when using the material according to the invention than would otherwise be the case.

Studies were repeated in a preliminary outdoors trial at both 77 GHz and 10 GHz and new and un-optimised dihedral structures were produced for this exercise. These structures were 300 mm×300 mm (30 mm peak-peak (p-p) dihedrals) for the 10 GHz application and 300 mm (length)×150 mm (width) (10 mm p-p dihedrals) for the 77 GHz application. At close range (6 m) the preliminary reflection results from an adult male (1.9 m tall) were 6 dB above the background level at 10 GHz. Reflection from a full sized mannequin (with no material according to the invention) was 3 dB above background. Reflection from a small panel (300 mm×150 mm) fitted with “small” dihedrals (10 mm p-p) was 7 dB above background, i.e. 4 dB better than with no material according to the invention, at 10 GHz (for which the 10 mm p-p structures are not optimal unless embedded in high dielectric material). The larger dihedrals and larger area (300 mm×300 mm) gave a reflected signal which was 26 dB (>400 times) better than the background at 10 GHz. When this panel (and mannequin) was rotated by 40 degrees the returned signal dropped to 6 dB above the background. However, the reduced projected area of the panel in this previous case, resulting from the change in presentation angle, would have contributed to most of this signal loss. The transmitting and receiving antennas at 10 GHz had antenna flare angles of 30 degrees, compared to the 77 GHz horns with a 5 degree flare angle, with the result that, in the 10 GHz measurement case, the projected beam intensity dropped much more quickly with distance and the received signal was received from a much larger “background” or “radar-painted” area (thus greatly increasing the background signal level for these antennas at this frequency).

Preliminary measurements at 100 GHz and at a range of 10 m, show that the reflection from an adult male and an uncoated mannequin was almost indistinguishable from the background at this frequency, but the reflection from a mannequin fitted with a single 300 mm×150 mm (10 mm p-p) panel formed of the material according to the invention was greater by between 10 and 100 times and over a range of incident angles (mannequin rotated with respect to the radar source). Significant improvements (by factors of another 10 to 1000-fold) are envisaged as the materials of the invention become more refined, and with panels of larger area.

The data which are illustrated in the referenced Figures were obtained from an experimental set-up wherein the MM wave source was an Agilent 85100 75 GHz-100 GHz source module which works on the principle of a five times multiplier of its input signal frequency, which in turn is generated by the output of an 8349B amplifier driven by a 8340A synthesiser.

The detector was an Agilent 11970W external mixer connected to an Agilent E4407B spectrum analyser. The mixer uses the 18^{th} harmonic of the local oscillator of the spectrum analyser, as a result of which output of the harmonic mixer suffers an average conversion loss of 40 dB relative to the input. Values of power detected have not been corrected for this conversion loss and for a 650 mm range to target the returned power (without CL correction) was between −60 dBm and −105 dBm (RAM return value), i.e. between −20 to −65 dBm.

The spectrum analyser noise floor in all the measurements was 105 dBm. If the conversion loss of the detector is taken into account, it implies the source output power is around −4 dBm or 400 μW which is in agreement with expectations.

Two corrugated horn antennas were used, the transmitting horn was connected directly to the source output and the receiving horn was connected to the detector. The measurement scheme employed was the pseudo-monostatic arrangement, where the angle α, as shown below, is not quite zero (as in the monostatic case when the receiver doubles as the transmitter), but is small, since the transmitting and receiving antenna are placed side by side. The separation between the transmitter and the receiver was limited by the width of the horns and was small relative to the target distance, which was approximately 600 mm.

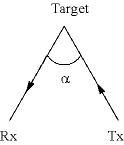

The spot size of a beam from an antenna at the measurement plane places a lower limit on the minimum sample size that can be measured. Thus, it is preferred that the sample size must be at least three times the beam width at the measurement plane in order to minimise diffraction effects. In order to experimentally verify the spot size at 60 cm from the transmitting horn, flat reflecting metal plates of varying dimensions were placed at the target, normal to the horn. The arrangement was such that the centre of the plate was aligned with the centre of the horn on each occasion. The measured reflection coefficients for different reflector dimensions are shown in Table 1.

TABLE 1

| Reflector square | Reflection |
|---|---|
| dimension (mm) | Coefficient (dBm) |
| 10 | 88.3 |
| 30 | 78.7 |
| 50 | 74.1 |
| 75 | 71.9 |
| 100 | 71.8 |
| 150 | 72.6 |

The observed levelling off of the measured reflection coefficient corresponds to the fact that most of the energy from the transmitting horn is incident upon a 50 by 50 mm area of the sample.

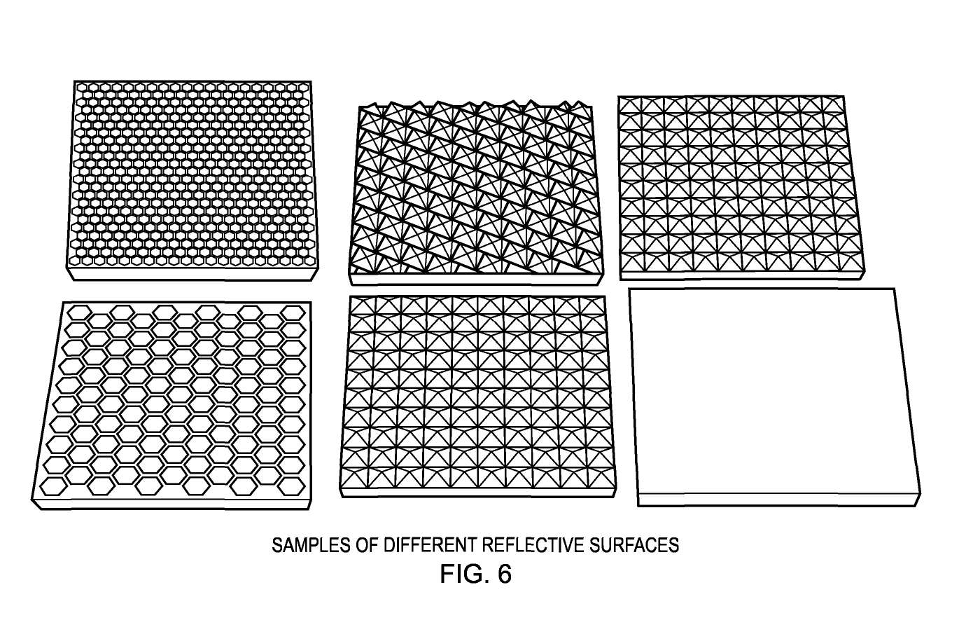

In FIG. 6, there are illustrated different reflecting surfaces according to the invention. On the left of the Figure are seen hemisphere patterns of two different sizes, whilst retro reflector patterns (also known as corner cube or tri-corner) made of three mutually perpendicular intersecting surfaces are shown in the centre. The pattern to the top right is a porro prism (or quad corner) containing four surfaces, whilst the bottom right illustration is of a planar Teflon® substrate on which all the surfaces have been machined. The surfaces of all materials were sprayed with nickel paint in order to create a conductive surface. Preferred surfaces comprise dihedral patterns or patchworks of dihedral and trihedral patterns.

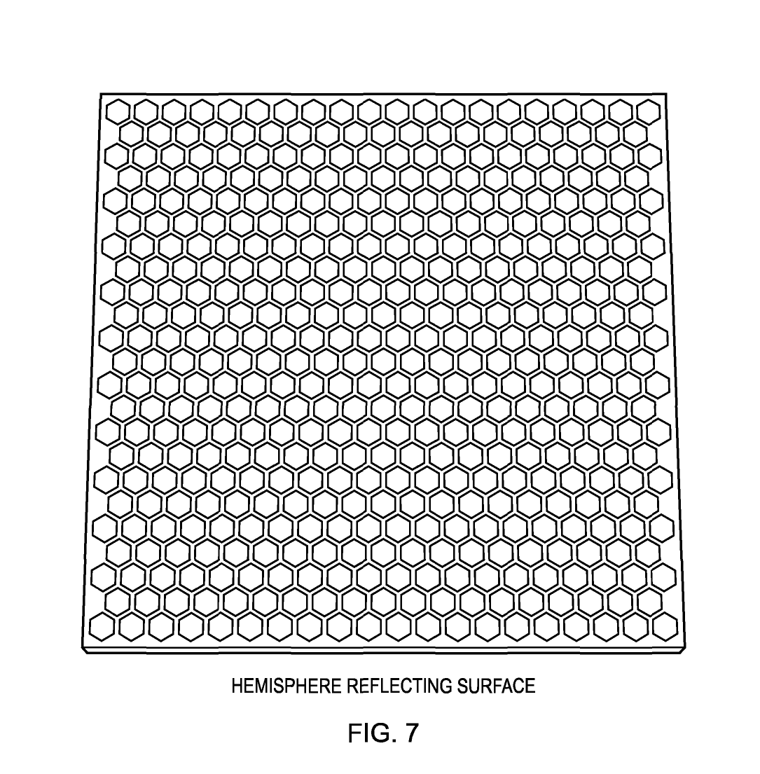

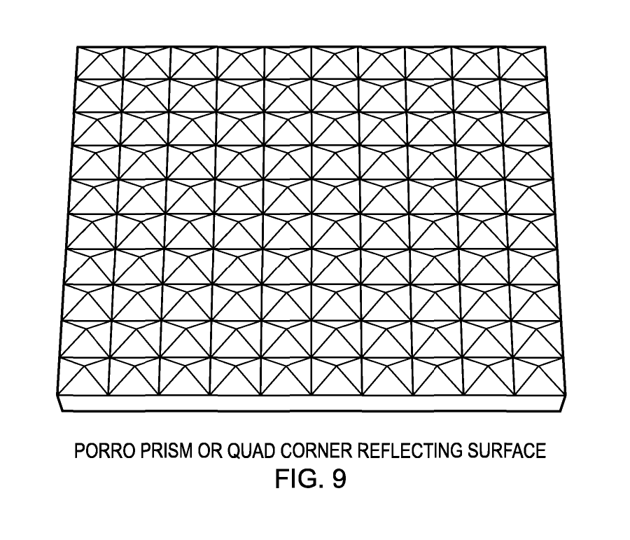

FIGS. 7, 8 and 9, respectively, provide more detailed views of a hemisphere reflecting surface, a retro reflector tri-corner reflecting surface, and a porro prism or quad corner reflecting surface.

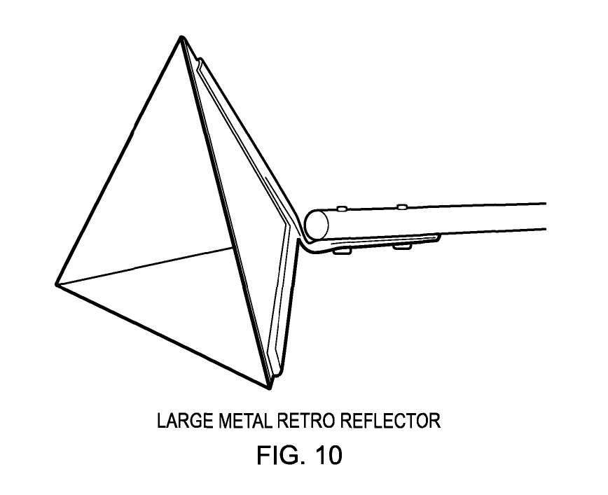

In FIG. 10 there is displayed a large single tri-corner metal retro reflector wherein the dimension of each surface aperture is 100 mm and the on-axis projected area is equivalent to 50 cm². Reflectivity measurements using this device are shown in FIG. 10, from which it is seen that power only drops off by about 10 dB for a rotation of up to about 30 degrees. Beyond this, a significant proportion of the projected beam is increasingly not “caught”, and returned by the open aperture of the corner; in other words the projected area decreases rapidly. An array of such structures would be expected to reflect almost 100% of the power incident upon them and it the analogous reflectors of smaller dimensions should maintaining such retro-reflective properties, such that an array of such devices can be easily incorporated in the lining of a garment in order to provide the desired level of performance.

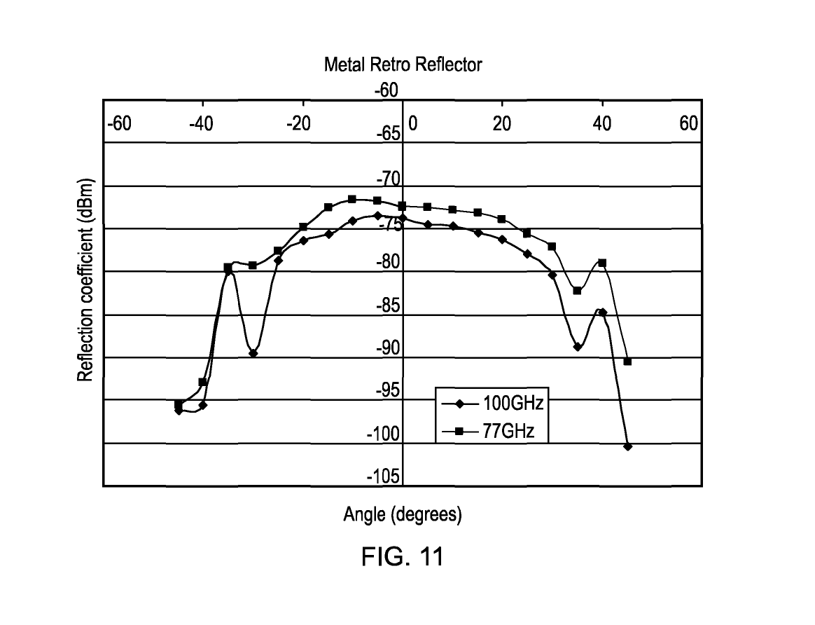

FIG. 11 provides a graphical representation of the angle dependent reflection from the large metal trihedral retro reflector of FIG. 10. Most notable is the strong retro-reflected return for angles up to 30 degrees off perpendicular−the gradual drop up to 30 degrees and the rapid drop after 40 degrees are simply effects related to the drop in projected area. By using a wrap around array of such reflectors, or other appropriate shapes, then the projected area would not be so strongly dependent on rotation or presentation angle—a human body would still present a sizable target if presented side-on.

From FIG. 11, it may be gleaned that there is a rapid fall in reflected power for a flat nickel plate from −73 dBm to less than −95 or −100 dBm, and this is similar to the data presented in FIG. 1. The flat PTFE plate shows a similar trend, falling from −80 dBm to −95 dBm. The other traces show a lower, but fairly uniform, amount of reflected power centred around −90 dBm, i.e. 20 dB lower than that of the flat plate at 0° rotation, or normal to the angle of incidence. The reasons for this significant drop are thought to be threefold: firstly the PTFE for these samples lacks an antireflection coating (ARC); then, largely because of this lack of an ARC, there is a significant degree of standing wave reflection within the PTFE slab; then, finally, the still small relative size of the individual reflecting shapes within the array (due to a permittivity εᵣ=2, rather than 6 or more) results in a greater proportion of diffuse scattering compared to the specular reflection observed with the large tri-corner metal retro reflector of FIG. 10. The reason for the background ripple which is clearly evident in the case of the “Small Retro” reflector from the measurement for angles from 15 degrees onwards, is considered to be an artefact arising from the effect of diffraction and standing waves in the relatively short test range, which would not, therefore, affect the measurement for a longer range. In effect the angular spread in the illuminating beam (which would not be present in a longer test range) has the consequence that there are significant phase differences between the incident wave when it impinges on the nearest and furthest portions of the reflecting surface when that surface is at increasing angles, and these out of phase components then cancel back at the receiver. Thus, in a longer test range the incident beam diversion would not be an issue, thereby raising the possibility of a composite surface of larger and smaller retro-reflector elements in the array. In the event that such ripples can be eliminated, then a best case reflection would be only ˜12 dB lower than that for the flat plate at normal incidence.

FIG. 12 shows the reflectivity of various reflector shapes of the type shown in FIG. 6 embedded in PTFE and without the use of an anti-reflection coating according to the invention, wherein the radiation is incident on a PTFE surface. Both the metal plate and flat dielectric slab show a significant on-axis return which then drops rapidly beyond a few degrees off-axis. The trihedral shapes give a weaker on-axis signal but the average reflection is maintained through a broad range of angles. The “standing wave” or ripple effects or oscillations in the returned signal strength are related to the relatively small size of the reflective surface used in this experiment, together with the proximity and related diffraction related phase cancellation of the return. A longer test range and larger reflective surface would reduce these effects, as would the use of an anti-reflection coating suited to the radar frequencies being used.

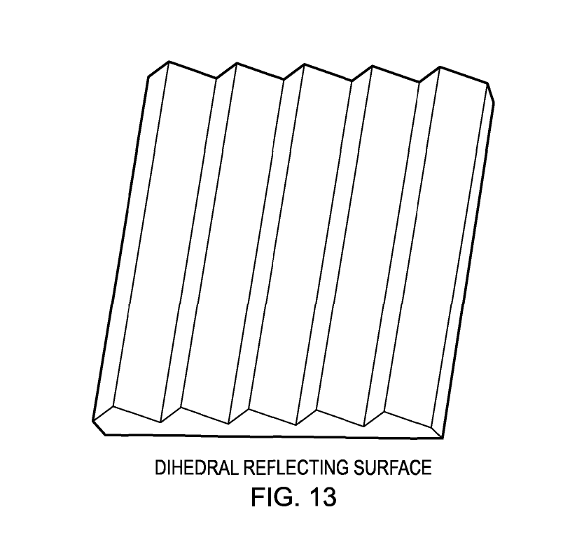

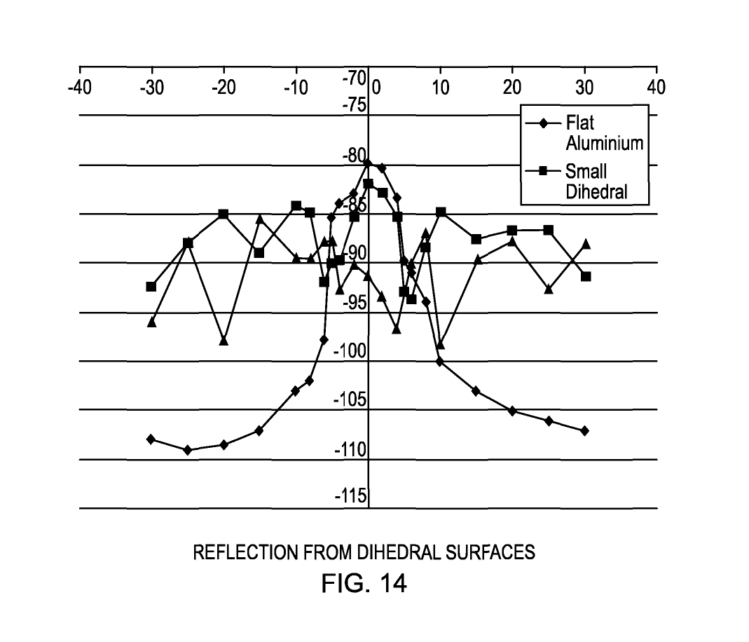

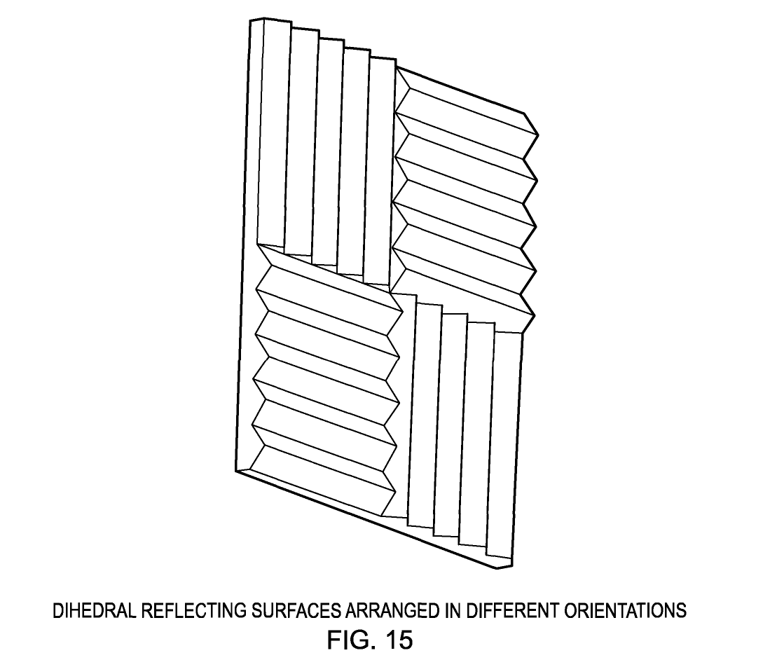

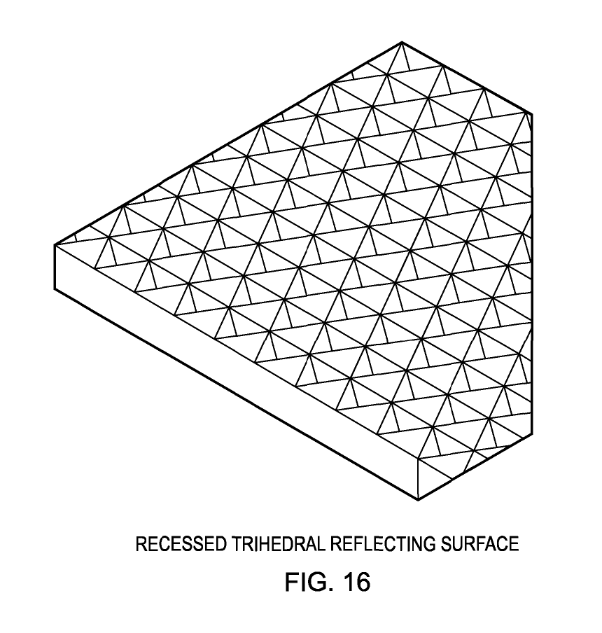

FIG. 14 illustrates reflection data observed with the dihedral surface of FIG. 13, and it is seen that the average return from a small (10 mm peak to peak) dihedral plate is about 20% of that of an optimum “gold-standard” flat plate on-axis, but this level of return is maintained over a much larger range of angles.

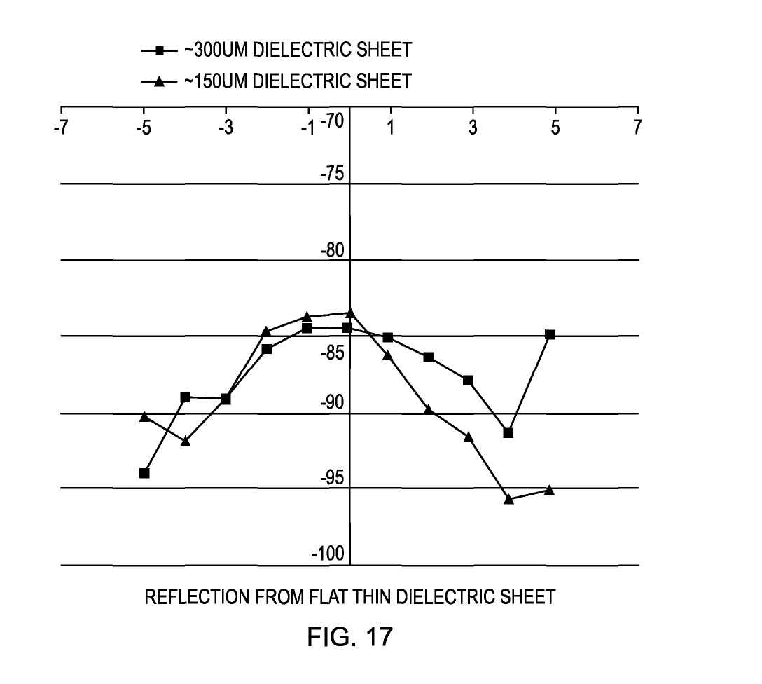

FIG. 17 shows the reflectivity which is measured with a flat thin dielectric sheet (εᵣ ˜80), and provides evidence of the high reflectivity observed on-axis, which is comparable to that of a flat metallic plate.

The reflective material and textile garments according to the invention provide a highly efficient means for the reflection of incident radar radiation and offer significant benefits in terms of the visibility of wearers to drivers of oncoming vehicles in poor and dark light conditions, thereby facilitating a marked improvement in road safety statistics and also find potential application in a variety of other hazardous working environments.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-24. (canceled)

25. A reflective material, adapted for the efficient retro-reflection of radiation emitted by radar, wherein said material comprises a multiplicity of reflective entities, wherein said multiplicity of reflective entities are comprised in at least one reflective surface or electrically conducting surface, and wherein said at least one reflective surface or electrically conducting surface comprises an electrically conductive coating, a high permittivity material, a foil, a film or a fabric formed from electrically conducting fibres or filaments.

26. A reflective material as claimed in claim 25 wherein said electrically conductive coating comprises a metal, wherein said metal optionally comprises nickel.

27. A reflective material as claimed in claim 25 wherein said reflective entities are embedded in a substrate.

28. A reflective material as claimed in claim 27 wherein said substrate comprises a textile or non-woven substrate which is suitable for integration within a garment construction.

29. A reflective material as claimed in claim 25 wherein said radiation emitted by radar has a wavelength in the microwave or millimetre wave or sub-millimetre wave region.

30. A reflective material as claimed in claim 25 wherein said reflection of radiation comprises the retro-reflection of >50% of incident radiation.

31. A reflective material as claimed in claim 25 wherein said reflective entities comprise discrete shaped entities.

32. A reflective material as claimed in claim 31 wherein said shaped entities comprise di- or tri-hedral shaped entities.

33. A reflective material as claimed in claim 31 wherein the dimensions of said shaped entities are in the range of 2-5 mm (vertical height).

34. A reflective material as claimed in claim 31 wherein said discrete shaped entities are comprised of a high permittivity medium within a substrate.

35. A reflective material as claimed in claim 34 wherein said high permittivity medium comprises a material with permittivity in the range of 10-100.

36. A reflective material as claimed in claim 34 wherein said high permittivity medium comprises a ceramic material, wherein said ceramic material optionally comprises TiO2.

37. A reflective material as claimed in claim 25 wherein said reflective entities comprise shaped entities which are comprised in the machined surface of a reflecting substance.

38. A reflective material as claimed in claim 37 wherein said reflecting substance comprises a polymeric plastic material, wherein said polymeric plastic material optionally comprises polyethylene, polypropylene or polytetrafluoroethylene.

39. A reflective material as claimed in claim 38 wherein said reflecting substance is provided as a sheet material which is machined to provide a patterned surface.

40. A reflective material as claimed in claim 39 wherein said pattern is in the form of a hemisphere reflecting surface, retro reflector di-, tri- or quad-corner reflecting surface, or dihedral striped reflecting surface.

41. A textile garment comprising a reflective material as claimed in claim 25.

42. A textile garment as claimed in claim 41 which comprises an outer layer and at least one inner layer.

43. A textile garment as claimed in claim 42 which comprises a drop liner.

44. A method for the detection of an object body, said method comprising providing the object body with a material as claimed in claim 25 or a garment as claimed in claim 41, illuminating said object body with radar radiation, and detecting retro-reflected radar radiation emitted from said object body, wherein said object body optionally comprises a human being.
